(19) United States
(12) Patent Application Publication
(10) Pub. No.: US 2015/0281321 A1
(43) Pub. Date: Oct. 1, 2015

(54) REAL-TIME EVENT MONITORING AND VIDEO SURVEILLANCE WEB APPLICATION BASED ON DATA PUSH

(71) Applicants: Viachaslau Hrytsevich, Scarborough (CA); Ekaterina Balabanova, Scarborough (CA)

(72) Inventors: Viachaslau Hrytsevich, Scarborough (CA); Ekaterina Balabanova, Scarborough (CA)

(21) Appl. No.: 14/670,911

(22) Filed: Mar. 27, 2015

Related U.S. Application Data
(60) Provisional application No. 61/971,901, filed on Mar. 28, 2014.

(51) Int. Cl. H04L 29/08; H04L 29/06; H04N 7/18

(52) U.S. Cl. CPC H04L 67/02; H04L 67/26; H04L 67/10; H04L 67/18; H04N 7/181; H04L 65/4069; H04L 65/602

(57) ABSTRACT

The present invention is directed to a method and system for providing real-time, web-based reactive user interface. In the method and system real-time updates are pushed directly to a web page of a web browser; the system further notifies a web browser that updates are available for retrieval.

### CROSS-REFERENCE TO RELATED APPLICATIONS

This application claims the benefit of U.S. Provisional Application No. 61/971,901, filed Mar. 28, 2014.

### FIELD OF THE INVENTION

The present invention is directed to a method and system for providing real-time, web-based reactive user interface.

### BACKGROUND OF THE INVENTION

Currently, general poll based AJAX (Asynchronous JAVA and XML) Web UI operates with a single event as a data unit. Moreover, in current polling systems, a client would load a server with multiple requests (for example, a client polling a server for events from tens of cameras) and the server would need to know ahead of time what kind of data to collect and store for each client in each particular moment of time. The common design and architecture in existing systems of real-time web-based services uses a technology commonly referred to as AJAX. Such services rely on a constant poll of a server to provide updates to a webpage for display. Furthermore, such services require using server resources constantly, as the client browser has to make periodic requests to a server every few seconds in order to see if there is additional data to display. This dramatically increases the number of user-generated requests to web servers and their back-end systems (databases, or other). This leads in most cases to longer response times and/or additional hardware needs.

### SUMMARY OF THE INVENTION

The presently provided system uses data push process to provide real-time, reactive web user interface (UI) and gives several advantages over data polling of the prior art. The reactive nature of the present web-application allows operation over event stream abstraction with all generally applied to data stream processing rules (timeouts, throttling, and other orchestration methods).

In one embodiment, the present invention enables a web-application (and/or a user utilizing the web-application) to subscribe to new event streams dynamically without affecting other parts of the system. In this embodiment, the server can direct events from a sender to a new subscriber whenever they are available. In another embodiment, the server can subscribe to location events from a client and based on client location, the server dynamically filters the event stream being delivered to a client for the set of cameras and other events belonging to a particular client location.

In one embodiment, subscription disclosed herein is a dynamic process, and provides an abstraction to create flexible rules for client(s) and the server as to when to subscribe and when to unsubscribe to push updates (for example server can have a scheduler to determine when to send events from a particular camera to a client). In another embodiment, as the users subscribes to the server, the server controls/filters the outgoing stream of events. Consequently the set of rules can be flexible and one can determine through the server to whom, when, where to send alerts/provide access/send data to. Accordingly, additional implementations and variations are also within the scope of the invention. In another embodiment, the illustrated implementations discuss monitoring of data and application metrics. However, other parameters such as mouse movements, user typing and other events can be monitored and shared. Allowing users for example to share particular videos, highlight important moments on the video timeline with a mouse, or Get involved into a community chat within the same web UI.

In one embodiment, the invention is directed to a method comprising in a system comprising a device, a server, one or more cameras, data sensors, other devices producing stream of relevant data or events, the server in communication with the one or more cameras, establishing a bi-directional communication channel between the device and the server; receiving push notifications from the server over the bi-directional communication channel, the push notifications comprising data from the one or more cameras, the push notifications transmitted by the server when camera-based events are detected; and providing data received from the server in the push notifications in a single-page application in a browser at the device without refreshing the single-page application.

In another embodiment, the method of the present invention further comprises subscribing to the push notifications by: transmitting from the device to the server an event type of the camera-based events.

In yet another embodiment, the present invention comprises a method that comprises transmitting action data from the device to the server, the action data comprising data indicative of an action to implement when a given type of a camera-based event occurs.

In still another embodiment, the present invention comprises a system for reactive web-based user interface for real-time video monitoring and collaboration, the system comprising a device, a server, one or more cameras, data sensors, other devices producing stream of relevant data or events, the server in communication with the one or more cameras, establishing a bi-directional communication channel between the device and the server; receiving push notifications from the server over the bi-directional communication channel, the push notifications comprising data from the one or more cameras, the push notifications transmitted by the server when camera-based events are detected; and providing data received from the server in the push notifications in a single-page application in a browser at the device without refreshing the single-page application.

In another embodiment, the method of present invention further comprises a single-page web app, wherein a user web interface does not interrupt the monitoring of a video stream viewing experience while communicating with a server.

In a further embodiment, in the system of the present invention, a user device establishes a bi-directional communication channel between the device and the server.

In still another embodiment, the method of present invention, further comprises sending the collected and/or observed events to a central repository, from which a plurality of events can be generated for a subscribed user processor. In another embodiment, the application is of reactive nature, wherein, the web application subscribes to events on a server; the web application asynchronously reacts to events; filters are applied at the server side to determine which events to send to a client; and the filters can be stored by a user in a database for future use.

In an embodiment, the application subscribes dynamically to the events from the server based on sensed or/and other gathered data, including but not limited to user device geolocation event from a server with a command to listen to another event producer (e.g.: a collaborative user added a new camera); user device network conditions; and scheduled time.

In still another embodiment, the application's reaction in order to update its user interface presentation state due to received events/data is throttled based on sensed environment conditions including CPU cycles needed to process pushed events per a unit of time; battery live; hardcoded rules of the system: limit CPU cycles needed for the status update due to received events during the video playback to provide smooth video playing experience or sensed network conditions, battery left; and user-created rules of the system, including but not limited to aggregate events for a specified time, aggregate events of a specified type, and aggregated events for an N count.

In yet another embodiment, the server personalizes collected data and event streams before pushing them to a particular user device through filtering based on the user-created rules and sensed data including, but not limited to geolocation by IP or GPS coordinates of event producer or receiving user device, identity of event producer (e.g.: camera which belongs to this user), and security permissions.

In another embodiment, the server can dynamically change applied filters during the process of personalizing data and event streams before pushing to user due to rules, received events or sensed conditions including, but not limited to by time schedule; by reacting to the events from other users monitoring the same video stream; by reacting to the events from users in the same collaboration group (e.g. a user in your group marked current video frame as important); by reacting to sharing events (user shared camera or video recording with the rest of users in group); and by changes in network condition.

In one another embodiment, the method of the present invention comprises linking the user event to the collected data storing the user event and the collected data, and in yet another embodiment the data describing the collected data includes at least a time-stamp, user identity, permission information, event identity, event data (e.g. camera clicked, archive deleted, record marked as important, record shared).

In a further embodiment, the method of encoding application entities such as groups of video producers (cameras) as “chained filters/transformers” working over stream of events or/and data whereas, “chained filters/transformers” entity is a chain of filters or/and transformer functions. Filters/transformers are functions operating on data and events, composable and satisfy monadic laws. Filters/transformers work on typed input event/data and produce typed output event/data.

In still another embodiment, the method for application to store such “chained filters/transformers” on a server and link them to a particular user identity, includes but is not limited to identity information of particular “chained filters/transformers”, their name, unique ID, and types of input and output data.

In yet another embodiment, the application and server can dynamically determine which “chained filters/transformers” to use for a particular event/data stream by using, including but not limited to input types, or combination of input type and requested output type, provided identities.

In another embodiment, the method for creating new “chained filters/transformers” entity by applying new filter/transformer to original “chained filters/transformers”.

In still another embodiment, the application receives encoded entities as “chained filters/transformers” and presents them to the user.

In yet another embodiment, the user interface provides means to create and manage the said “chained filters/transformers” and in anther embodiment, “chained filters/transformers” can be augmented with Time To Live timespan.

In still another embodiment, the server removes expired saved “chained filters/transformers” based on Time To Live timespan information.

In a further embodiment, the user interface removes expired saved “chained filters/transformers” based on Time To Live timespan information from its local storage.

In another embodiment, the “chained filters/transformers” can be augmented with security descriptors determining which groups of users are allowed to find, download and modify saved “chained filters/transformers”.

In yet another embodiment, saved “chained filters/transformers” is shared on a server with other users.

In still another embodiment, the user application provides a user with an interface to browse and find saved on a server “chained filters/transformers”. And in one embodiment the server and user application will remove shared expired “chained filters/transformers” based on Time To Live timespan.

In another embodiment, the user application provides a user with an interface for modifying shared “chained filters/transformers” by other users.

In still another embodiment, the user application provides a user with an interface to save and share modified “chained filters/transformers” as a new entity.

In one embodiment, the method according to the present invention for server and user application to remove modified “chained filters/transformers” based on original shared “chained filters/transformers” Time To Live timespan.

In still another embodiment, the results of event stream processed by “chained filters/transformers” are presented to user by changing presentation state of user interface. In yet another embodiment, the application receives event stream, applies corresponding “chained filters/transformers” to this particular event stream and updates the UI presentation state with a result; for example a user can create group of cameras for a specific set of events in a specific order (motion events at specified location during specified time will satisfy group filter chain and therefore video producer which generated such event will be placed in the said group).

In another embodiment, the method of the present invention provides where the decisions of how to modify presentation state to present results are performed dynamically based on but not limited to the following sensed and/or other gathered data form factor, orientation, and current CPU and other I/O resources available.

In still another embodiment, the decisions of how to modify presentation state change dynamically with the changes that include but are not limited to the following sensed and/or other gathered data time of day, network conditions changing, and battery availability.

In one embodiment, where the user interface provides a user with means to create and manage rules to determine how results of said event/data stream processed by “chained filters/transformers” are presented by changing presentation state of user interface.

In still another embodiment, the application can only change presentation state based on results of event stream processed by chained filter/transformers.

In another embodiment, further restrictions can be applied to a user application to only change the presentation state of a user interface based on results of event/data stream processed by specific “chained filters/transformers”.

In a further embodiment, the user application automatically downloads from server specific “chained filters/transformers” based on but not limited to user identity, security information, user location (e.g. administrator creates new group of cameras and shares it with all other users).

In still another embodiment, the user interface is further restricted from accessing raw event/data pushed by the server and can only access the result of event/data stream processed by specific “chained filters/transformers”.

In another embodiment, the application provides uninterrupted experience in unreliable network conditions.

In yet another embodiment, the user application monitors connection with a server. And in one embodiment, the user application sends all generated events to server upon reconnect.

In a further embodiment, the application monitors connection with the user device. And in still another embodiment, the user application stores all generated events in case of disconnected situation with a server. In yet another embodiment, the user application optimistically updates its state and presentation state of interface based on the user action.

In an embodiment, the application synchronizes the application state with the server upon the network reconnect. And in still another embodiment, the server receives the latest state update from the application. In another embodiment, the server merges latest state update from application with state update available at database for this particular application.

In still another embodiment, the server sends merged state updates to the application.

In another embodiment, the server pushes event notifications with new changes due to the changes mentioned as above to all subscribed to the said changes devices.

In one embodiment, when the device is offline, a server will send notifications to the user via one or more means including but not limited to any social networking websites, chat application, email, SMS. Users can also schedule a time to receive such communications.

Various objects, features, aspects and advantages of the inventive subject matter will become more apparent from the following detailed description of exemplary embodiments, along with the accompanying figures in which like numerals represent like components.

### BRIEF DESCRIPTION OF THE DRAWINGS

FIG. 1 is an exemplary embodiment that depicts a general functional scheme according to one aspect of the present invention.

FIG. 2 is an exemplary embodiment that depicts the event push from Camera to UI according one aspect of the present invention.

FIG. 3 is an exemplary embodiment that depicts the events' push from the UI to the camera according to one aspect of the present invention.

FIG. 4 is an exemplary embodiment that depicts the reactive character of the UI according to one aspect of the present invention.

FIG. 5 is an exemplary embodiment that illustrates the reactive user interface screen according to one aspect of the present invention.

FIG. 6 is an exemplary embodiment of discontinued situations according to one aspect of the invention.

FIG. 7 is an exemplary embodiment of the user reconnect according to one aspect of the present invention.

FIG. 8 is an exemplary embodiment of the broadcasting process of the UI updates to other subscribers according to one aspect of the present invention.

FIG. 9 is an exemplary embodiment of the platform—agnostic, according to one aspect of the present invention.

### DETAILED DESCRIPTION OF THE INVENTION

A method and system for providing real-time, web-based reactive user interface is disclosed. In the method and system real-time updates are pushed directly to a web page of a web browser; the system further notifies a web browser that updates are available for retrieval. A bi-directional connection between the client and the server is established and allows the server and client to use the data push process to send the data between each other. The server aggregates and monitors this information for multiple reasons: statistics, throttling connection depending on a client round-trip delay, dynamically subscribe and unsubscribe client from certain event sources based on IP or location information, etc. The client can be a user's web-app, camera, encoder server or any other central processing unit (CPU) device.

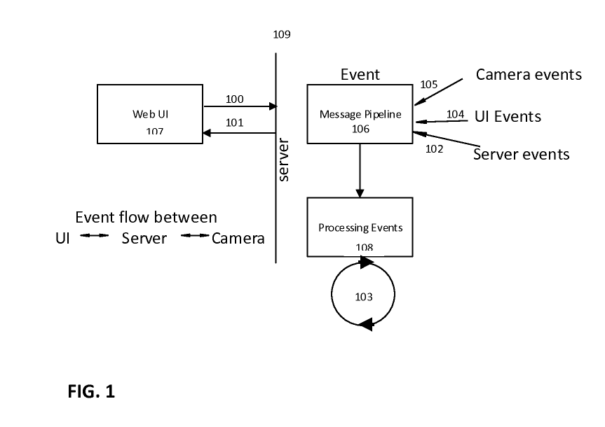

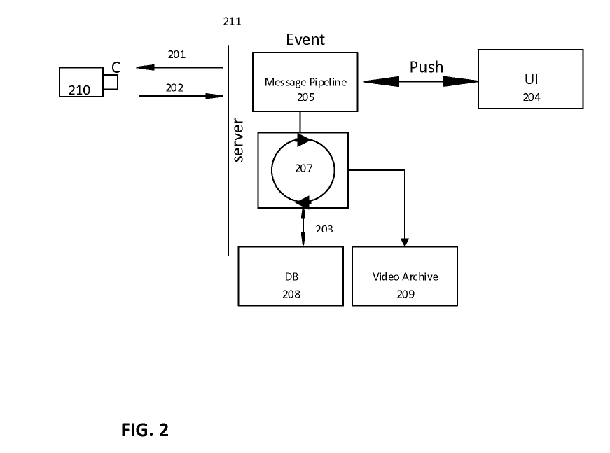

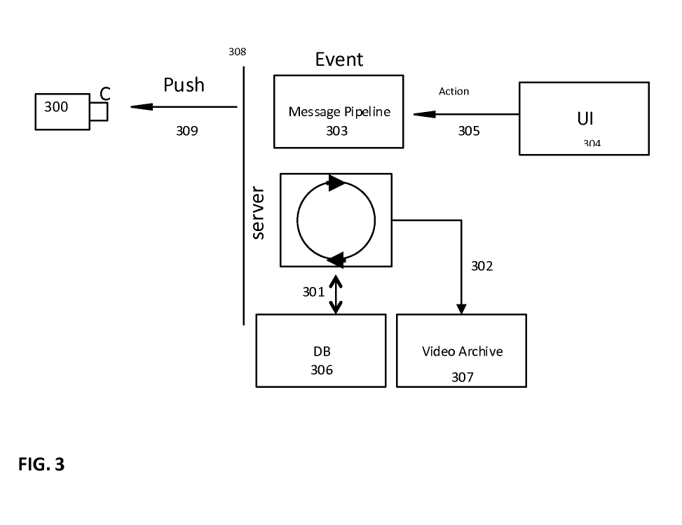

FIG. 1. is an exemplary embodiment of the general functional scheme of the present invention. In one embodiment, user generated events 100 are pushed to the server 109 and the server events 101 are pushed back to the Web UI 107. In yet another embodiment, the events' push from camera to the UI 105 is covered in detail in FIG. 2. In an embodiment, continuous processing of events 103 include but are not limited to video recognition and sensor alerts. In this embodiment, there is no page refresh upon the presentation state update based on the event from the server 109, due to the Java script base. Accordingly, there is no limit on the number of events UI 107 subscribes to and receives, due to server pushing event in contrast to UI polling server for updates. This embodiment also provides resiliency to disconnection or bad network problems, and allows easy creation of complex workflows due to the reactive nature of UI treating events as a stream of data. In contrast the polling process would treat events as actions and they are inherently not composable. In an embodiment the events' push from the UI 104 to the camera is described in detail in FIG. 3.

FIG. 2 is an exemplary embodiment describing the event push from Camera 210 to UI 204. In an embodiment, the commands from the server 211 including but not limited to pan tilt zoom (PTZ) are sent to the camera 201. In another embodiment, the camera events including but not limited to motion, tampering and the video stream are sent 202 to the server 211. In an embodiment, the camera events are saved in the database 208 and the settings, data, etc., are pushed 203 to the UI 204.

FIG. 3 is an exemplary embodiment illustrating the events' push 309 from the UI 304 to the camera 300. In an embodiment, the user-generated event/action 301 is saved to the database 306. In another embodiment, in 302, lookup data needed to send command to the camera 300 and video archive 307 is being updated if necessary.

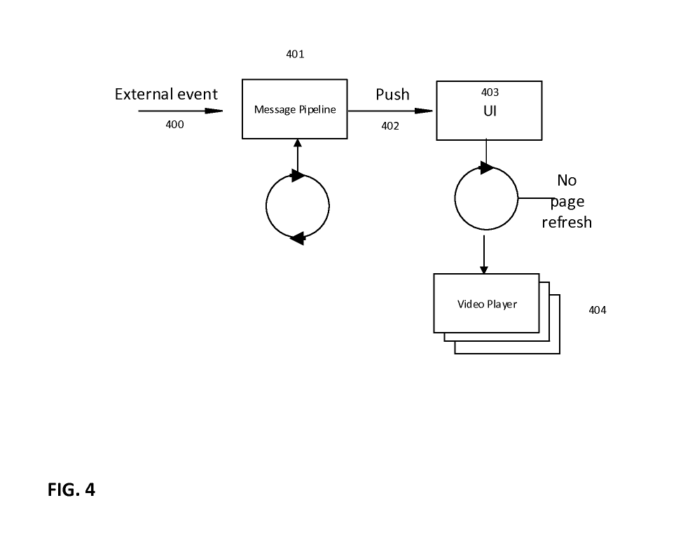

FIG. 4 is an exemplary embodiment describing the reactive character of the UI 403. In an embodiment, upon the event pushed 402 to the UI (e.g. motion event), the system displays this motion event in a new video player 404 achieving the following steps:

1. the user can see the latest events on a part of the screen without interrupting his current activity.

2. the page is not being refreshed 405 hence none of the other video players 404 displays are interrupted.

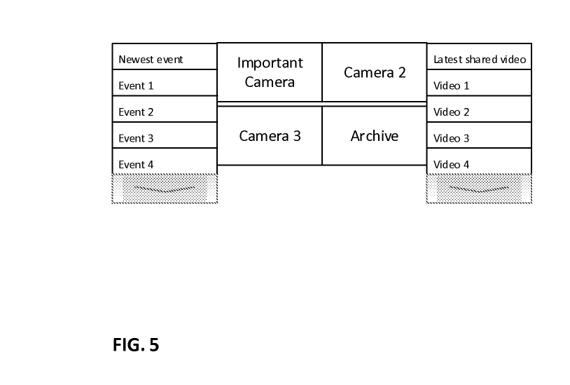

FIG. 5 is an embodiment illustrating the reactive user interface screen. In another embodiment, reactive nature of UI allows easy customization to the rules of UI changes based on the occurring events (i.e., user can choose how to present on screen motion events, for example through a pop up video player with motion event for 10 seconds). Unlike other systems that have the rules prebuilt, in an embodiment, the current system described herein allows the user flexibility to create his own rules.

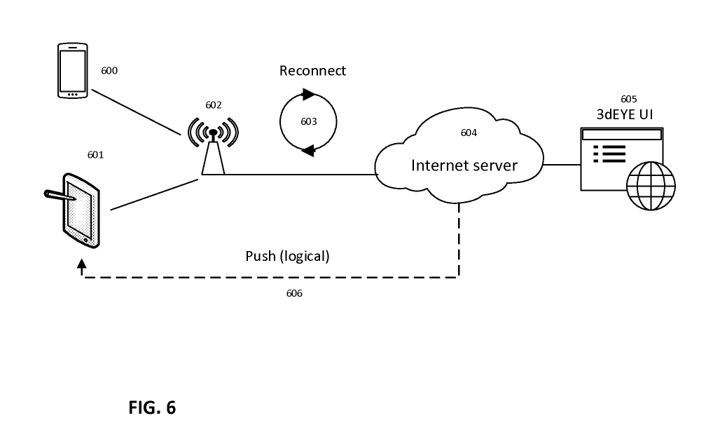

FIG. 6 is another exemplary embodiment describing discontinued situations. In an embodiment, UI 605 works well in disconnected situations, wherein the server 604 will resend the messages 606 including but not limited to events from cameras, other users as well as Web UI actions (user-generated events such as a bookmark of a moment in video or sharing camera record and others) will get synchronized with the server 604.

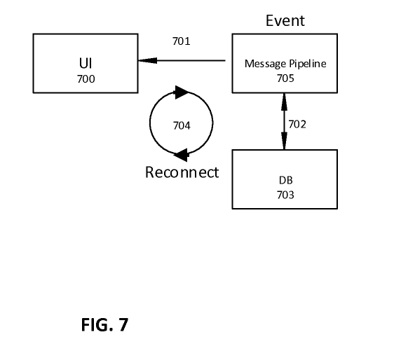

FIG. 7 is an exemplary embodiment, wherein upon the user reconnect 704—the latest updates are pushed to the client 700. In another embodiment 701, push updates are sent back to the UI 700. In yet another embodiment 702, the data is received from database 703 and stored in the database 703.

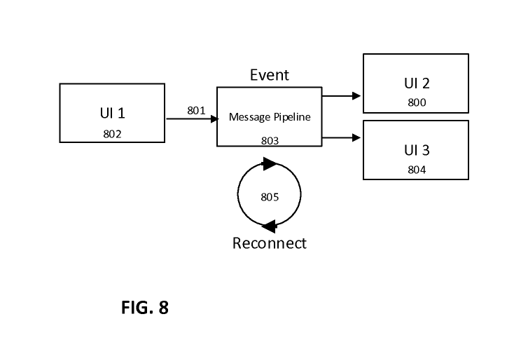

According to another embodiment as depicted in FIG. 8, the broadcasting process of the UI updates to other subscribers is described. In this embodiment, user (UI) 1, 802 sends updates to the server 803 and the server 803 pushes them to (UI) 2, 800, and (UI) 3, 804. In another embodiment 801, the updates include but are not limited to bookmarking a moment in the video recording, sharing a camera record, and new saved record.

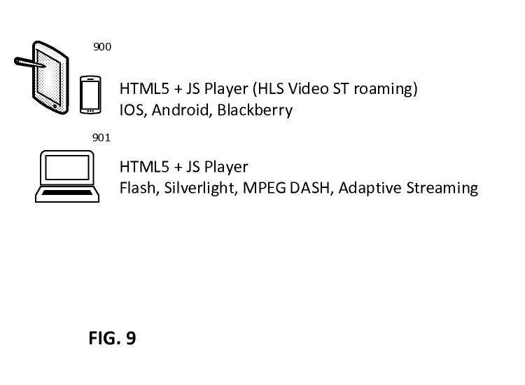

FIG. 9 is an exemplary embodiment of the platform—agnostic, according to one aspect of the present invention. In this embodiment, the user-generated events in the UI including but not limited to chat messages, sharing record, sharing camera are shared between the user interfaces on different devices 900; 901 as well as between UI's connected to each other by some metric, e.g., users in the same group.

Thus, specific embodiments of a method and system for providing real-time, web-based reactive user interface have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A method comprising:
in a system comprising: a device, a server, one or more cameras, data sensors, other devices producing stream of relevant data or events, the server in communication with the one or more cameras:
establishing a bi-directional communication channel between the device and the server;
receiving push notifications from the server over the bi-directional communication channel, the push notifications comprising data from the one or more cameras, the push notifications transmitted by the server when camera-based events are detected; and
providing data received from the server in the push notifications in a single-page application in a browser at the device without refreshing the single-page application.

2. The method of claim 1, further comprising: subscribing to the push notifications by:
transmitting from the device to the server an event type of the camera-based events.

3. The method of claim 2, further comprising: transmitting action data from the device to the server, the action data comprising data indicative of an action to implement when a given type of a camera-based event occurs.

4. A system for reactive web-based user interface for real-time video monitoring and collaboration, the system comprising:
a device, a server, one or more cameras, data sensors, other devices producing stream of relevant data or events, the server in communication with the one or more cameras:
establishing a bi-directional communication channel between the device and the server;
receiving push notifications from the server over the bi-directional communication channel, the push notifications comprising data from the one or more cameras, the push notifications transmitted by the server when camera-based events are detected; and
providing data received from the server in the push notifications in a single-page application in a browser at the device without refreshing the single-page application.

5. The method of claim 4, further comprising a single-page web app.

6. The method of claim 5, whereby a user web interface does not interrupt the monitoring of a video stream viewing experience while communicating with a server.

7. The system of claim 4, wherein the user device establishes a bi-directional communication channel between the device and the server.

8. The method of claim 4, further comprising sending the collected and/or observed events to a central repository, from which a plurality of events can be generated for a subscribed user processor.

9. The method of claim 4, wherein the application is of reactive nature, wherein:
the web application subscribes to events on a server;
the web application asynchronously reacts to events;
filters are applied at the server side to determine which events to send to a client; and
the filters can be stored by a user in a database for future use.

10. The method of claim 9, wherein the application subscribes dynamically to the events from the server based on sensed or/and other gathered data, including but not limited to:
user device geolocation event from a server with a command to listen to another event producer (e.g.: a collaborative user added a new camera);
user device network conditions; and
scheduled time.

11. The method of claim 9, wherein the application's reaction in order to update its user interface presentation state due to received events/data is throttled based on sensed environment conditions including:
CPU cycles needed to process pushed events per a unit of time;
battery live;
hardcoded rules of the system: limit CPU cycles needed for the status update due to received events during the video playback to provide smooth video playing experience or
sensed network conditions, battery left; and
user-created rules of the system, including but not limited to:
aggregate events for a specified time,
aggregate events of a specified type, and
aggregated events for an N count.

12. The method of claim 9, wherein the server personalizes collected data and event streams before pushing them to a particular user device through filtering based on the user-created rules and sensed data including, but not limited to:
geolocation by IP or GPS coordinates of event producer or receiving user device;
identity of event producer (e.g.: camera which belongs to this user); and
security permissions.

13. The method of claim 9, wherein the server can dynamically change applied filters during the process of personalizing data and event streams before pushing to user due to rules, received events or sensed conditions including, but not limited to:
by time schedule;
by reacting to the events from other users monitoring the same video stream;
by reacting to the events from users in the same collaboration group (e.g. a user in your group marked current video frame as important);
by reacting to sharing events (user shared camera or video recording with the rest of users in group); and
by changes in network condition.

14. The method of claim 9, comprising linking the user event to the collected data storing the user event and the collected data.

15. The method of claim 9, wherein the data describing the collected data includes at least a time-stamp, user identity, permission information, event identity, event data (e.g. camera clicked, archive deleted, record marked as important, record shared).

16. The method of encoding application entities such as groups of video producers (cameras) as “chained filters/transformers” working over stream of events or/and data whereas:
“chained filters/transformers” entity is a chain of filters or/and transformer functions;
filters/transformers are functions operating on data and events, composable and satisfy monadic laws; and
filters/transformers work on typed input event/data and produce typed output event/data.

17. The method of claim 16 for application to store such “chained filters/transformers” on a server and link them to a particular user identity, including but not limited to identity information of particular “chained filters/transformers”, their name, unique ID, and types of input and output data.

18. The method of claim 16, where application and server can dynamically determine which “chained filters/transformers” to use for a particular event/data stream by using, including but not limited to input types, or combination of input type and requested output type, provided identities.

19. A method for creating new “chained filters/transformers” entity by applying new filter/transformer to original “chained filters/transformers”.

20. The method of claim 16, where application receives encoded entities as “chained filters/transformers” and present them to the user.

21. The method of claim 16, where user interface provides means to create and manage the said “chained filters/transformers”.

22. The method of claim 16, where “chained filters/transformers” can be augmented with Time To Live timespan.

23. The method of claim 16, where the server removes expired saved “chained filters/transformers” based on Time To Live timespan information.

24. The method of claim 16, where user interface removes expired saved “chained filters/transformers” based on Time To Live timespan information from its local storage.

25. The method of claim 16, where “chained filters/transformers” can be augmented with security descriptors determining which groups of users are allowed to find, download and modify saved “chained filters/transformers”.

26. The method for sharing saved “chained filters/transformers” on a server with other users.

27. The method of claim 26, where user application provides a user with an interface to browse and find saved on a server “chained filters/transformers”.

28. The method of claim 26, where the server and user application removes shared expired “chained filters/transformers” based on Time To Live timespan.

29. The method of claim 26, where the user application provides a user with an interface for modifying shared “chained filters/transformers” by other users.

30. The method of claim 26, where user application provides a user with an interface to save and share said in claim 29 modified “chained filters/transformers” as a new entity.

31. The method of claim 26 for server and user application to remove modified shared “chained filters/transformers” based on original shared “chained filters/transformers” Time To Live timespan.

32. The method of claim 4, where the results of event stream processed by “chained filters/transformers” are presented to user by changing presentation state of user interface. The application will receive event stream, apply corresponding “chained filters/transformers” to this particular event stream and update the UI presentation state with a result; for example a user can create group of cameras for a specific set of events in a specific order (motion events at specified location during specified time will satisfy group filter chain and therefore video producer which generated such event will be placed in the said group).

33. The method of claim 32, where the decisions of how to modify presentation state to present results are performed dynamically based on but not limited to the following sensed and/or other gathered data:
form factor,
orientation, and
current CPU and other I/O resources available.

34. The method of claim 32, where the decisions of how to modify presentation state change dynamically with the changes that include but are not limited to the following sensed and/or other gathered data:
time of day,
network conditions changing, and
battery availability.

35. The method of claim 32, where the user interface provides a user with means to create and manage rules to determine how results of said event/data stream processed by “chained filters/transformers” are presented by changing presentation state of user interface.

36. The method of claim 4, where application can only change presentation state based on results of event stream processed by chained filter/transformers.

37. The method of claim 36, where further restrictions can be applied to a user application to only change the presentation state of a user interface based on results of event/data stream processed by specific “chained filters/transformers”.

38. The method of claim 36, where user application automatically downloads from server specific “chained filters/transformers” based on but not limited to user identity, security information, user location (e.g. administrator creates new group of cameras and shares it with all other users).

39. The method of claim 36, where user interface is further restricted from accessing raw event/data pushed by the server and can only access the result of event/data stream processed by specific “chained filters/transformers”.

40. The method of claim 4, wherein the application provides uninterrupted experience in unreliable network conditions.

41. The method of claim 40, where the user application monitors connection with a server.

42. The method of claim 40, where the user application sends all generated events to server upon reconnect.

43. The method of claim 40, where the application monitors connection with the user device.

44. The method of claim 40, where user application stores all generated events in case of disconnected situation with a server.

45. The method of claim 40, where user application optimistically updates its state and presentation state of interface based on user action.

46. The method of claim 40, wherein the application synchronizes the application state with the server upon the network reconnect.

47. The method of claim 40, where the server receives the latest state update from the application.

48. The method of claim 40, where the server merges latest state update from application with state update available at database for this particular application.

49. The method of claim 40, where the server sends merged state updates to the application.

50. The method of claim 40, where the server pushes event notifications with new changes due to the changes mentioned in claim 49 to all subscribed to the said changes devices.

51. The method of claim 40, where when the device is offline, a server sends notifications to the user via one or more means including but not limited to any social networking websites, chat application, email, SMS, wherein users can also schedule a time to receive such communications.
